(19) United States
(12) Patent Application Publication
(10) Pub. No.: US 2014/0199430 A1
(43) Pub. Date: Jul. 17, 2014

(54) FOOD PRODUCT AND METHOD OF USING SUCH FOR REDUCING DESIRE TO EAT AND USE IN A WEIGHT CONTROL SCHEME

(71) Applicants: Salomon Leendert Abrahamse, 3133 AT Vlaardingen (NL); David Jason Mela, 3133 AT Vlaardingen (NL); Henricus Petrus F. Peters, 3133 AT Vlaardingen (NL); Jay Phillip Tapper, Wayne, PA (US)

(72) Inventors: Salomon Leendert Abrahamse, 3133 AT Vlaardingen (NL); David Jason Mela, 3133 AT Vlaardingen (NL); Henricus Petrus F. Peters, 3133 AT Vlaardingen (NL); Jay Phillip Tapper, Wayne, PA (US)

(21) Appl. No.: 14/130,351

(22) PCT Filed: Jun. 19, 2012
(86) PCT No.: PCT/EP2012/061644

§ 371 Date: Feb. 3, 2014

(30) Foreign Application Priority Data
Jul. 4, 2011 (EP) 11172458.9

(51) Int. Cl. A23L 1/29

(52) U.S. Cl. CPC A23L 1/293; A23L 1/296
USPC 426/2; 426/564

(57) ABSTRACT

A method for reducing, in an individual, the desire to eat a meal or a snack in between meals, by consuming by said individual, in between meals or as an adjunct to a meal, a portion of at least 50 ml and less than 150 ml, of a pourable or spoonable edible aerated composition having an overrun of at least 100%, which aerated composition contains less than 50 kcal/portion.

### FIELD OF THE INVENTION

The present invention relates to the field of food products that can reduce a feeling of craving in an individual for food, especially in between meals, and use of food products in methods (e.g. as part of a weight control scheme) to achieve a reduction of feelings of craving.

### BACKGROUND OF THE INVENTION

There is a large group of (human) individuals that desire to control weight (e.g. loose weight, or maintain a consistent weight, i.e. to avoid weight increase), for medical reasons and/or for cosmetic reasons (because they believe it enhances their appearance). For most people, this will result in a desire to consume fewer calories, e.g. through dieting by following a diet plan or scheme, or self-imposed eating restrictions. Frequently, such dieting or self-imposed eating restrictions will include avoiding or reducing “snacking” or reducing the desire to “snacking”, as such snack food is usually calorie-dense food. Many individuals are familiar with this urge or desire from time to time, but it may be especially prevalent in individuals who change their usual eating habits by trying to consume fewer calories per day, e.g. by reducing their usual snacking behaviour, by reducing on the size or calorie content of their main meals, or by following a diet plan or diet regime to control body weight (whether for weight reduction or maintaining a desired body weight).

“Snacking” as referred to above relates to the consumption of food having a limited volume (i.e. usually less volume than what is considered a (main) meal, such as breakfast, lunch or dinner) and ingested (“snacking occasion”) usually not as a (main) meal, and usually not on the time when the individual would mostly consume a meal but rather in between meals. The amount of food consumed as snack on a snacking occasion is typically from about 30 to about 250 g, more specifically from about 50 to about 150 g.

Typical examples of snacking-moments in the western diet are mid-morning (some time between the time for breakfast and lunch time, or put differently: about 2 to about 4 hours after getting up), the afternoon snack (e.g. some time between lunch and dinner, e.g. from 1 hour after lunch to 1 hour before a dinner), or the evening snack (e.g. from e.g. 1 hour after dinner up to a few minutes prior to sleeping.

Typical snack foods are colloquially known as “bars” (from their shape): typically solid confectionary units of 50-100 g per piece containing ingredients like (one or more of) chocolate, nuts, cookies, caramel, candied fruit. Branded examples include Mars bars, Milky Way bars, Twix, etcetera. Also plain or filled chocolate bars or pieces are typical snack foods, as are cookies, candy, sweets, but also savoury variants such as crisps or chips (crispy, deep fried slices of potato) or other starchy sweet or savoury nibbles, but also fruit like apples or bananas. The typical caloric content of a typical snack food portion is from about 100 to about 200 kcal.

Despite that consumption of such snack food may take away the urge for consuming (more) snackfood, the above referred desire or urge to consume a snack food can be perceived as undesired or unpleasant by an individual, especially for those who want to control or reduce their intake in calories, in view of the caloric content of such snackfood.

WO 2009/027954 discloses the use of beverages comprising alginate, which gels in the stomach after ingestion, for suppressing appetite and/or imparting satiety. Said beverages are low in calorie, and have a volumes of 500 ml.

US 2010/0278981 discloses a food composition that has the ability to control food cravings, increase satiety, promote a feeling of fullness and provide the user a method to maintain a healthy weight and/or achieve weight loss. Said food composition relates to ingestible chocolate or caramel flavoured confectionary compositions.

US 2008/0081840 discloses a food composition having high protein level and comprising DHA, preferably for use as meal replacement. Such composition can be used for individuals to control their weight.

WO 2008/028994 discloses satiety-inducing compositions for e.g. weight management. Essential ingredients are viscous soluble dietary fibre or other thickening agent and fat or fatty acids.

WO2008/022857 discloses shelf stable satiety enhancing liquid compositions comprising a specific combination of pectin and alginate.

US 2003/143287 discloses a nutritional supplement for weight management, which nutritional supplement comprises a low glycemic index carbohydrate source, a protein source, a fat source, and further a source of green tea extract, a source of 5-hydroxytryptophan, and a source of chromium.

B. J. Rolls et al (Am J Clin Nutr 2000, 72, 361-368) discloses the results of research on increasing the volume of a food by incorporating air. The test persons had been given a strawberry flavoured milkshake of 300 ml volume (unwhipped) or the same whipped to 450 ml or 600 ml volume.

### SUMMARY OF THE INVENTION

Thus, it is an object of the present invention to provide ways to reduce, in an individual, the desire to eat a meal or a snack in between meals, and/or to decrease feelings of hunger in an individual, and/or to increase feelings of satiety in an individual, and/or to decrease the desire, in an individual, to prospective food consumption, and/or to decrease feelings of craving in an individual for food or a snack and/or to increase the feeling, in an individual, of fullness, and/or to reduce appetite, in an individual, for a meal or a snack in between meals.

Additionally and/or alternatively, it is an object to deal with, avoid, reduce, delay, or overcome the desire or urge to consume snack food (e.g. reduce feelings of craving for a snack food). This is in particular the case for such desire or urge occurring in between main meals, such as mid-morning (some time between the time for breakfast and lunch time, or put differently: about 2 hours to about 4 hours after getting up), the afternoon snack (e.g. some time between lunch and dinner, e.g. from 1 hour after lunch to 1 hour before a dinner), or the evening snack (e.g. from e.g. 1 hour after dinner up to a few minutes prior to sleeping. It is furthermore desired that such can be achieved whilst consumption of calories by the individual concerned is low: preferably below 50 kcal per desired snacking event. It is furthermore desired that such can be achieved by an edible composition which fits the generally understood size or volume of a snack food, being an edible composition of a weight of about 30 to about 250 g, more specifically from about 50 to about 150 g. Such limited amount is also furthermore desired as it allows consumption other than snacking, e.g. as an adjunct to a (main) meal such as breakfast, lunch or dinner. Furthermore, it is desired that the solution, if it is something edible, that it has an agreeable or likable texture or mouthfeel and/or is well palatable, e.g. that it gives a hedonistic pleasure.

It has now been found that the above objectives may be achieved, at least in part by a method for reducing, in an individual, the desire to eat a meal or a snack in between meals, which method comprises consuming by said individual, in between meals or as an adjunct to a meal, a portion of at least 50 ml and less than 150 ml, preferably at least 50 ml and less than 100 ml, of an edible aerated composition, which aerated composition:
is pourable or spoonable,
has an overrun of at least 100%,
has a composition comprising by weight 50-99.5% water, a foaming agent and a stabiliser,
contains less than 50 kcal/portion, preferably less than 40 kcal/portion, more preferably less than 30 kcal/portion.

It has now been found that the above objectives may be achieved, at least in part by the use of an edible aerated composition, which aerated composition:
is pourable or spoonable,
has an overrun of at least 100%,
has a composition comprising by weight 50-99.5% water, a foaming agent and a stabiliser,
contains less than 50 kcal/portion, preferably less than 40 kcal/portion, more preferably less than 30 kcal/portion
   for reducing, in an individual, the desire to eat a meal or a snack in between meals, by consuming by said individual, in between meals or as an adjunct to a meal, a portion of at least 50 ml and less than 150 ml, preferably at least 50 ml and less than 100 ml, of said aerated composition.

It has now been found that the above objectives may be achieved, at least in part by an edible aerated composition which aerated composition:
is pourable or spoonable,
has an overrun of at least 100%,
has a composition comprising by weight 50-99.5% water, a foaming agent and a stabiliser,
contains less than 50 kcal/portion, preferably less than 40 kcal/portion, more preferably less than 30 kcal/portion
   for use in the treatment of reducing, in an individual, the desire to eat a meal or a snack in between meals, said treatment comprising consuming by said individual, in between meals or as an adjunct to a meal, a portion of at least 50 ml and less than 150 ml, preferably at least 50 ml and less than 100 ml, of said aerated composition.

It has now been found that the above objectives may be achieved, at least in part by the use of an edible aerated composition, which aerated composition:
is pourable or spoonable,
has an overrun of at least 100%,
has a composition comprising by weight 50-99.5% water, a foaming agent and a stabiliser,
contains less than 50 kcal/portion, preferably less than 40 kcal/portion, more preferably less than 30 kcal/portion,
   in the manufacture of a medicament for reducing, in an individual, the desire to eat a meal or a snack in between meals, by consuming by said individual, in between meals or as an adjunct to a meal, a portion of at least 50 ml and less than 150 ml, preferably at least 50 ml and less than 100 ml, of said aerated composition.

In the above method or use, the reduction, in an individual, the desire to eat a meal or a snack in between meals can take the form of or be expressed by one or more of:
decreasing feelings of hunger in an individual,
increasing feelings of satiety in an individual,
decreasing the desire, in an individual, to prospective food consumption,
decreasing feelings of craving in an individual for food or a snack,
increasing feeling, in an individual, of fullness,
reducing appetite, in an individual, for a meal or a snack in between meals.

### DETAILED DESCRIPTION OF THE INVENTION

“Reducing, in an individual, the desire to eat a meal or a snack in between meals” herein encompasses:
decreasing feelings of hunger in an individual, for a meal or a snack in between meals,
increasing feelings of satiety in an individual,
decreasing the desire, in an individual, to prospective food consumption,
decreased feelings of craving in an individual for food or a snack,
increased feeling, in an individual, of fullness,
reducing appetite, in an individual, for a meal or a snack in between meals,
   and other associated expressions of eating motivation related to reducing, in an individual, the desire to eat a meal or a snack in between meals.

“Snack” herein means food consumed in a limited amount as expressed by a portion having a weight of from about 30 to about 250 g, more specifically from about 50 to about 150 g, and which is not intended and/or marketed as a main meal, meal, or meal replacer, but intended and/or marketed as something that can be consumed on its own and/or intended and/or marketed for consumption at moments in between (main) meals, e.g. between breakfast and lunch, between lunch and dinner, between dinner and going to bed. “Snacking” herein means the consumption of a snack, not as a meal, main meal or meal replacer.

“Adjunct to a meal” herein means food consumed as part of or with a (main) meal, or intended or preferred to be consumed as part of or with a (main) meal. A non-limiting example of an adjunct to a meal is a dessert, or a starter (aka entrée in french language).

“Meal” herein means one or more of breakfast, lunch, or dinner. “Main meal” is herein the meal that provides the largest amount of calories on a given day.

“Edible” and “foodstuff” herein encompasses something suitable for human consumption, be it by eating and/or drinking, thus including solid, spoonable and drinkable foodstuffs.

The “time-to-return-to-baseline” can be calculated by using the Weibull modelling technique, and this is how it is referred to herein. The Weibull modelling technique has previously been applied to many types of data with a characteristic rise and decay, and has been shown to be relevant for its use to establish parameters for gastric emptying (e.g. Elashoff, Reedy, & Meyer, 1982) or drug absorption kinetics (e.g. Jamei, Turner, Yang, Neuhoff, Polak, Rostami-Hodjegan, & Tucker, 2009). This method has now been applied to satiety data and allows for quantitative estimation of the duration of satiety and related self-report responses, and statistical comparison among treatments. This is further set out by Schuring, E A H et al: Statistical design and analysis of satiety trials comparing foods and food ingredients. International Journal of Obesity, 32, S197 (2008). Elashoff, J. D., Reedy, T. J., & Meyer, J. H. (1982). Analysis of gastric emptying data. Gastroenterology, 83, 1306-1312. Jamei, M., Turner, D., Yang, J. Neuhoff, S., Polak, S., Rostami-Hodjegan, A. & Tucker, G. (2009). Population-Based Mechanistic Prediction of Oral Drug Absorption. American Association of Pharmaceutical Scientists Journal, 11, 225-237.

“Fat” herein encompasses edible lipophilic matter, including triglycerides of fatty acids, both solid and liquid.

“Aerated” herein means a composition which comprises a plurality of gas bubbles. The gas can be any compound gaseous at ambient pressure and temperature. Examples include: N₂, N₂O, CO₂, He, O₂, air, and mixtures thereof, and thus is not limited to air. “Aerated composition” and “foam” are herein used interchangeable, and are to be understood as to mean the same.

Surprisingly, it was found that by the present invention a decrease, in an individual, of feelings of hunger, and/or an increase of feelings of satiety, and/or a decrease in the desire, a decrease of individuals' estimate of their prospective food consumption, and/or a decrease in the feeling of craving for food or a snack, and/or an increase of the feeling of fullness, and/or a reduction of appetite for a meal or a snack in between meals. This makes the present invention very suitable for achieving control or reduction of appetite for a meal and/or a snack and/or a good hunger control and/or for reducing, in an individual, the desire to eat a meal or a snack in between meals, and/or for preventing undesired weight gain.

Without wishing to be bound by theory, it is believed that the properties of the present edible aerated composition and its use in low volumes or low weight per portion required which yet still give effects as set out above, make the product very suitable to be marketed as a snack or snack food and/or as an adjunct to a meal, especially to those which are intending to reduce their caloric intake. This is contrary to many satiety and/or satiation-inducing compositions, for which consumption of large portions are recommended (e.g. 300 ml or 300 g and more), and/or which are positioned as meal replacers and/or contain considerable amounts of calories.

In the method and use according to the present invention, the portion of aerated composition is preferably consumed by said individual in between meals. More preferably, this means between breakfast and lunch or between lunch and dinner, and even more preferably in the interval from 90 minutes after breakfast to 90 minutes before lunch, and/or in the interval from 90 minutes after lunch to 90 minutes before dinner, and/or more than 90 minutes after dinner.

The more conventional snack foods derive their satiety and/or satiation inducing effect mainly from the calories and/or fat it contains. In the present invention (both the method and use), it is preferred that wherein the aerated composition has a calorie density of less than 2 kilo calories/gram, preferably less than 1 kcal/gram, more preferably less than 0.7 kcal/gram. Alternatively expressed, the aerated composition for use in the methods and uses according to this invention preferably has a calorie density of between 0.01 to 1 kilo calories/ml of aerated composition, preferably of between 0.1 to 0.5 kcal/ml of aerated composition. This low calorie content, yet good size and its effect, in an individual, on one or more of a decrease of feelings of hunger and/or an increase of feelings of satiety and/or a decrease in the desire, a decrease of individuals' estimate of their prospective food consumption, and/or a decrease in the feeling of craving for food or a snack, and/or an increase of the feeling of fullness, and/or a reduction of appetite for a meal or a snack in between meals, makes the product very suitable to be positioned as a snack or snack food or as an adjunct to a meal, even for individuals that desire to control their caloric intake.

As to the composition edible aerated composition in the method and use of the present invention, it is:
is pourable or spoonable,
has an overrun of at least 100%,
has a composition comprising by weight 50-99.5% water, a foaming agent and a stabiliser,
contains less than 50 kcal/portion, preferably less than 40 kcal/portion, more preferably less than 30 kcal/portion.

The edible aerated composition in the method and uses of the invention may be pourable or spoonable. According to one embodiment, the product is non-pourable. Such a non-pourable product typically exhibits spoonable rheology defined as follows: yield value of >50 Pa, when extrapolating from shear rates between 100 and 300 s⁻¹, a Bingham viscosity <500 mPa·s between shear rates of between 100 and 300 s⁻¹, a failure at stress at a strain of <0.5 Radians. The yield stress is determined at a temperature of 20° C. using a Haake VT550 viscometer. According to another embodiment, the edible foam product is pourable. A pourable product offers the advantage that it can be drunk. If the product is drunk rather eaten, the chance of undesirable density increase as a result of mastication is minimised—for example bread is high overrun product, but practically all air is lost during mastication.

In the composition of the method and use according to the present invention, the foaming agent preferably comprises, for a good aerated composition, one or more of:
a food grade water-soluble emulsifier having an HLB value of at least 8, preferably at least 9, more preferably at least 12,
a food grade protein;
food grade amphiphatic particles having a contact angle at air/water interface between 70 and 120 degrees, and preferably having a volume weighted mean diameter of 0.02 to 10 micron (μm).

Examples of preferred food grade water-soluble emulsifier having an HLB value of at least 8, preferably at least 9, more preferably at least 12 herein are: sodium docecyl sulfate (SDS), SSL, Tween 20, Tween 40, Tween 60 (POE 20 sorbitan monostearate), Molec MT (enzymatically hydrolysed lecithin) and L1695 (lauric ester of sucrose ex Mitsubishi-Kasei Food Corp.), and DATEM (diacetyl tartaric acid ester of monoglyceride).

Preferred food grade proteins comprise dairy proteins such as whey protein and/or casein protein and sources thereof, as well as vegetable proteins like soy protein, meat- and fish derived protein, and egg protein like albumin. When used as sole foaming agent, such food grade proteins are preferably used in an amount of from 1 to 7% by weight. Preferred food grade amphiphatic particles herein comprise one or more of cocoa particles.

As to the stabiliser, e.g. to give the product sufficient physical stability, e.g. to allow some time between preparation of the aerated composition, it is preferred that the stabilizer comprises a dietary fibre or a sucrose ester. Preferred amounts in this context are: from 0.1 to 5% by weight. Too little may not provide the desired stability, too much may make aeration difficult.

Suitable dietary fibres in this context are one or more of the group consisting of: carrageenan, xanthan, cellulose, gellan, locust bean gum, with xanthan being the most preferred stabiliser (as it provides stabilising without too much viscosity increase).

Fat may be present in the compositions in the methods and uses according to this invention, but such is preferably kept at a low level, so as not to induce too much calories to the composition. Also, fat may act detrimental on the stability of the aerated compositions. Hence, in the compositions in the methods and uses herein, the edible aerated composition comprises fat in an amount of less than 2% by weight, preferably less than 1.8% by weight, more preferably between 0 and 1.8% by weight, even more preferably between 0 and 1.5% by weight, even more preferably form 0.01 to 1.5% by weight.

Next to the foaming agent, stabiliser, water and optionally fat, other components that may be present include carbohydrates, (non-caloric) sweeteners, flavouring components.

Commonly known aerated compositions that are consumed as a snack product are ice cream portions. However, e.g. for ease of supply chain and/or distribution channel, the aerated composition as in use in the present method and uses is preferably a non-frozen composition (preferably such means: products which are sold, marketed and/or consumed at product temperatures above 0° C.).

As said, the compositions in the method and uses of the present invention are such that they have an overrun of at least 100%. According to a preferred embodiment, the edible aerated product in the method and uses of the present invention has an overrun of at least 120%, more preferably of at least 150%, and even more preferably between 150% and 800%. The overrun of an aerated product is calculated using the following equation:

Overrun=100%×(V_{foam product}−Vₘᵢₓ)/Vₘᵢₓ

V_{foam product}=Volume of a sample of the edible aerated product
Vₘᵢₓ=Volume of the same sample after the dispersed gas phase has been removed.

The edible aerated composition in the method and uses of the present invention typically contains at least 50 vol. % of a dispersed gas phase (which equates to an overrun of 100%). Preferably, the product contains at least. 60 vol. % of a dispersed gas phase. The vol. % of gas phase (φ) contained in the present product may suitably be determined by measuring the density of pre-aerated solution, ρ₀, and the density of the aerated product, ρ_{f} and applying the following equation: 0=100(1−ρ_{f}/ρ₀) and is related to the overrun as follows: 0=100 Overrun/(100+Overrun). The gas phase in the present product can comprise air or any other gas that is considered safe for food applications.

It is believed that the benefits of the present invention may be obtained with any type of edible aerated composition as specified for the method and uses of this invention, but preferably it exhibits sufficient in-mouth and gastric stability. In this connection it is preferred that said aerated composition have a foam stability such that said aerated composition has a bench-life stability of at least 1 hour, wherein bench-life is determined by:
preparing a sample of the aerated composition
transferring a certain amount into a measuring glass cylinder which has been previously tared on a balance
measuring the total foam volume
measure the total mass of the foam
covering the top of the cylinder with parafilm to prevent evaporation.
measure the liquid volume at the bottom of the cylinder
placing the measuring glass cylinder on a lab bench at ambient temperature.
recording the total foam volume and drained liquid from the foam at 5 minute intervals for a period of at least 60 minutes.
calculating overrun for each time point.

If within 60 minutes one or more of foam collapse, severe creaming, and severe disproportionation has occurred resulting in a reduction of overrun of more than 50%, the aerated composition does not have a sufficient bench-life stability.

More preferably, the aerated composition as in use in the methods and uses of the present invention has a physical (foam) stability such that the foam has a half life in the stomach of at least 20 minutes, preferably at least 30 minutes, more preferably of at least 45 minutes. “Foam half life in the stomach” herein is the gastric retention time where 50% of the foam volume ingested remains present as an aerated composition in the stomach. The presence of an aerated composition in the stomach, and thus the half life, can be determined by visualisation techniques as known in the medical profession. Of these, MRI imaging or CT scanning are preferred techniques, as they directly show the presence of foam, air and liquid. Ultrasound imaging can also be used for this, but due to differences in image quality and the interpretation of it a large enough set of test persons would be needed, as a person skilled in the art of ultrasound imaging would know. Also, with ultrasound imaging an aerated composition in the stomach as such cannot be visualised using ultrasound imaging, but the presence of foam can be derived from the reappearance of antral motility and ultrasound signal after the foam has left the stomach. Also, these imaging techniques can also be used to determine whether an aerated composition has a sufficient stability to pass the mouth and be present for some time as an aerated composition.

Even more preferably, the aerated compositions as in use in the method and uses of the present invention have a very high in-mouth stability and gastric stability. Such high gastric stability of the aerated product can be apparent from the time (t_{1/2}) needed to achieve a reduction in overrun of 50% under gastric conditions. The aerated product of the present invention exhibits a t_{1/2} of more than 30 minutes. The high in-mouth stability of the present aerated product is evidenced by a reduction in overrun of less than 35% when a sample of the product is subjected to a stability test in which conditions of shear are applied that are similar to those observed in the mouth. The aforementioned parameter t_{1/2} is determined in a gastric stability test involving combining 400 ml of the aerated product with 15 ml of an artificial gastric juice comprising 60 mg of 1:1 (wt) pepsin/lipase mix (pepsin from hog stomach, activity 724 U/mg, Fluka BioChemika, cat. no. 77160; lipase from Rhizopus oryzae, activity 53 U/mg, Fluka BioChemika, cat. no. 80612) in 1M HCl containing 150 mM NaCl and 5 mM KCl. The aerated product is placed in a glass cylinders (length 200 mm, diameter 60 mm) and the artificial gastric juice is poured on top of the foam product. The cylinders are placed in a thermostated shaking water bath (37° C.), operating at a shaking rate of 1.2 s⁻¹, while the stability of the foam product is monitored.

The in-mouth stability of an aerated product as referred to in the previous paragraph can determined by introducing a predetermined volume of an edible areated product in a glass funnel (diameter 100 mm, neck length 100 mm, neck diameter 10 mm), which is connected to a silicone tube (length 400 mm, diameter 12×8 mm). The middle part of the silicone tube is inserted into a peristaltic pump Verderflex 2010 (Verder Ltd, Leeds, UK) operating at 60 rpm. After the processing in the peristaltic pump the sample is collected in a glass measuring cylinder and the product volume and product weight are measured immediately. In the shear test described above the aerated products in the methods and uses of the present invention typically show a reduction in overrun of less than 30%, preferably of less than 25%, most preferably of less than 22%. In contrast, known edible aerated products, such as chocolate mousse and whipped cream, show decreases in overrun that are well in excess of these percentages.

According to another preferred embodiment, the product obtained from the in-mouth stability test described above still exhibits an overrun of at least 100%, more preferably of at least 120%, and even more preferably at least 150%. Edible foam products that are capable of retaining a high overrun when subjected to conditions of shear that are similar to those observed during mastication and that additionally exhibit high stability under gastric conditions are extremely useful for the purposes of this invention. According to a particularly preferred embodiment, the aforementioned criteria are also met by the aerated products in the present method and invention if the shear stability test is conducted at a temperature of 37° C., thus reflecting the prolonged in-mouth stability of the product under conditions of shear that are similar to those exerted during mastication.

The benefits of the aerated product in the present invention are particularly pronounced in case the in-mouth and gastric stability is very high. Accordingly, in a particularly preferred embodiment t_{1/2} exceeds 45 minutes, even more preferably it exceeds 60 minutes, even more preferably it exceeds 90 minutes and most preferably t_{1/2} exceeds 120 minutes.

The edible aerated compositions for use in the methods and uses as specified herein can be prepared by any suitable means. The aerated compositions may be manufactured, packed and marketed in an aerated form, but it is also possible to prepare a non-aerated product which is packed and marketed, which is then aerated some time or immediately before consumption, either by the individual or at a point of sale. A convenient way (and one which can easily give aerated compositions of high stability) to offer such to users is when the composition for use in the method and uses of this invention is packed as a non-aerated (e.g. liquid) composition in a pressurised container in a liquid form. By this, the pressurised container can hold the edible liquid (non-aerated) composition and a propellant, which liquid composition can be released from the container by activating a valve (on the container) to produce an edible aerated product. Hence, more preferably, the invention further relates to the use in the method and uses of the present invention of a pressurised container further comprising a propellant, and wherein the pressurised container is equipped with a valve, wherein the liquid can be released from the pressurised container by activating said valve to produce the aerated composition for the method and uses according to this invention. Typically, the edible aerated product thus obtained has a density that is much lower (e.g. 40% lower) than that of the liquid composition in the container. According to a preferred embodiment, the edible aerated product produced upon activation of the valve has the same composition as the edible liquid composition (gas phase not being included).

Suitable propellants in this include compressed gases, especially liquefied gasses. Preferably, the propellant employed is selected from N₂O, N₂, CO₂, air and combinations thereof. Most preferably, the propellant employed is selected from N₂O, N₂, CO₂ and combinations thereof. Typically, the propellant contained in the pressurised container has a pressure of at least 2 bar, more preferably at least 3 bar. Usually, said pressure does not exceed 12 bar.

The stability of the edible aerated product, especially if it is produced in situ from a pressurised aerosol system, is affected by the composition of the gas that is retained within the aerated product. In order to generate a very stable aerated product, it is advantageous to include a gas that has limited water-solubility. Air, for instance, is not particularly suitable as e.g. oxygen has a relatively high solubility in water. According to a particularly preferred embodiment, the edible aerated product in the present invention contains a gas that is less soluble in water than air (at a temperature of 37° C. According to another preferred embodiment, relative to air, the gas contained in foam product contains elevated levels of one or more of the following gasses: N₂, N₂O, CO₂, He, O₂. Here the term “elevated” means that the concentration of at least one of said gasses is at least 10% higher than in air.

The gas bubbles contained within the edible aerated composition in the method and uses according to this invention can vary widely in size. Typically, the air bubbles in the product have a volume weighted mean diameter in the range of 5-500 μm, preferably of 10-200 μm. The volume weighted mean diameter of the gas bubbles is suitably determined by means of optical microscopy.

It has been found that the compositions as specified in the methods and uses herein, provide an unparallelled “satiety (or satiation) per kilo calorie”, even when used in small amounts. This is in particular attractive for individuals desiring to control food intake and finding it hard to cope with the “feelings of craving” for food, especially but not exclusively some time after a meal. Hence, the invention further relates to an edible, portionable composition, wherein said composition is an edible aerated composition which
is pourable or spoonable,
has an overrun of at least 100%,
comprises by weight 50-99.5% water, a foaming agent and a stabiliser.
an energy content of between 1 and 35 kcal per portion,
wherein the amount of said composition in a portion is from 20 to 100 g composition,
and which composition provides a time-to-return-to-baseline (TTRTB) for hunger of at least 60 minutes per portion, after ingestion of a portion of 20 to 100 g of such composition, wherein the time-to-return-to-baseline is the measure of the hunger response over time, whereby time is estimated by the Weibull modelling technique.

Alternatively expressed, the invention further relates to an edible composition which provides, at an energy content of between 1 and 35 kcal per portion, for a portion of 20 to 100 g, a satiety per calorie, as expressed by a time-to-return-to-baseline for hunger of at least 2 minutes per kcal, after ingestion of a portion of 20 to 100 g of such composition (which composition is pourable or spoonable, has an overrun of at least 100%, comprises by weight 50-99.5% water, a foaming agent and a stabiliser), wherein the time-to-return-to-baseline is the measure of the hunger response over time, whereby time is estimated by the Weibull modelling technique.

Although the above is believed to be true also when comparing to all known non-aerated compositions at the energy content of between 1 and 35 kcal per portion, for a portion of 20 to 100 g, it is preferred that such is achieved by ingestion of a portion of an aerated composition. Hence, the invention further relates to an edible, portionable composition, said composition being an aerated composition having an overrun of at least 100%, having an energy content of between 1 and 50 kcal per portion, and which composition provides a time-to-return-to-baseline (TTRTB) for hunger of at least 60 minutes per portion, after ingestion of a portion of 20 to 100 g of such composition, wherein the time-to-return-to-baseline is the measure of the hunger response over time, whereby time is estimated by the Weibull modelling technique.

In the above, for specified aerated composition providing the specified TTRTB, it is preferred that a portion has a weight of between 20 and 100 g, more preferably from 50 to 100 g. Alternatively expressed, It is preferred that said composition is portioned in a volume of 35-150 ml aerated composition. In part volume and weight of these portions are linked, e.g. through the overrun of the composition. In this connection, it is preferred that the aerated composition has an overrun of at least 200%, preferably at least 250%, and preferably below 800%.

As said, it is believed that the hunger control and related properties are achieved at least partly independent of the calorie content of the composition. And as calories are usually kept low for snack or food offerings that are targeted at individuals who wish to control calorie intake, it is preferred that such composition has a calorie density of between 0.01 to 1 kcalories/ml of aerated composition, preferably of between 0.1 to 0.5 kcalories/ml of aerated composition.

The aerated compositions as specified providing the specified TTRTB for hunger can be offered as an aerated composition is packaged in an aerated form, preferably in portioned packs having a volume of between 25 to 150 ml, preferably between 35 and 125 ml. Alternatively, the aerated compositions may be produced from a pressurised container, wherein the container comprises the composition in unaerated form and a pressurised gas. Hence, it may be preferred that the composition, prior to being aerated, is packaged in a pressurised container.

The aerated compositions as specified providing the specified TTRTB for hunger preferably comprise by weight 50-99.5% water, a foaming agent and a stabiliser. In this, the stabilizer preferably comprises a dietary fibre or a sucrose ester, and for the dietary fibres it is preferred that such comprises one or more of the group consisting of: carrageenan, xanthan, cellulose, gellan, locust bean gum (with xanthan being most preferred as stabiliser in this context. As to the foaming agent for such compositions, such preferably comprises one or more of:
a water-soluble emulsifier having an HLB value of at least 8, preferably at least 9, more preferably at least 12,
a food grade protein
food grade amphiphatic particles having a contact angle at air/water interface between 70 and 120 degrees, and preferably having a volume weighted mean diameter of 0.02 to 10 micron (μm).

Fat may be present in such compositions, but preferably in an amount of less than 2% by weight, preferably less than 1.8% by weight, preferably from 0 to 1.5% by weight.

Again, the aerated compositions as specified providing the specified TTRTB for hunger are preferably non-frozen compositions.

Like for the methods and uses as set out herein, it is believed that the benefits of the present invention may be obtained with any type of edible aerated composition as specified for the method and uses of this invention, but preferably it exhibits sufficient in-mouth and gastric stability. In this connection it is preferred that said aerated compositions have a stability to the same extent as set out hereinbefore w.r.t. the compositions and uses.

The aspect of the present invention that the compositions as specified providing the specified TTRTB for hunger provide an unparallelled “satiety (or satiation) per kilo calorie”, even when used in small amounts, makes this very attractive for use in a scheme for achieving body weight control. Hence, the invention further relates to a scheme for achieving body weight control in an individual, said scheme comprising instructions for consumption of compositions as specified providing the specified TTRTB for hunger, between meals or as an adjunct to a meal (for reducing the feeling of craving in an individual for a meal or a snack in between meals). Also, the invention further relates to the use, as a snack food, of an edible, portionable composition, wherein said composition has an energy content of between 1 and 35 kcal per portion, wherein the amount of said composition in a portion is from 20 to 100 g composition, and which composition provides a time-to-return-to-baseline for hunger of at least 60 minutes per portion, after ingestion of a portion of 20 to 100 g of such composition, wherein the time-to-return-to-baseline is the measure of the hunger response over time, whereby time is estimated by the Weibull modelling technique.

Likewise, the invention further relates to the use, as a snack food, of an edible, portionable composition, said composition being an aerated composition having an overrun of at least 100%, having an energy content of between 1 and 50 kcal per portion, and which composition provides a time-to-return-to-baseline for hunger of at least 60 minutes per portion, after ingestion of a portion of 20 to 100 g of such composition, wherein the time-to-return-to-baseline is the measure of the hunger response over time, whereby time is estimated by the Weibull modelling technique, and further to all preferred embodiments w.r.t. the compositions presented herein.

### Example

### Study Design

The study used a random allocation, parallel design, with treatments balanced across test days. Each subject group was given a single exposure to a single volume of a foamed liquid, each portion having a volume of 10, 25, 50, 100, 150 or 250 ml. This product was given as a mid-morning snack (at 10.30 am) following a fixed 250 kcal breakfast given at 08.00 am. Self-reported eating motivation ratings (6 scales) were collected regularly from 155 minutes prior to consumption of the test product and for 3 hours afterwards.

### Subjects

Healthy normal weight and overweight male and female participants (age 18-50 yr, BMI 20-32 kg/m²) were recruited from local area of the research centre. Only normal and low-restraint eaters were included, based on the Revised Restraint Scale (Polivy et al., 1978; Federoff et al., 2003). Any subject with a tendency toward a diagnosable eating disorder (anorexia nervosa or bulimia) was also excluded based on the SCOFF questionnaire (Morgan et al., 1999). From the eligible participants identified, 144 were admitted onto the study. Potential volunteers were trained on completion of visual analogue scales (VAS) for subjective ratings of ingestive behavior, and were familiarized with the test product and the study design. The 144 participating subjects were randomized into groups of 24 subjects per treatment, with groups matched for gender mix, age and body weight (mean within 5 yr and 5 kg). Ten subjects were withdrawn from the study for reasons unrelated to the study products. Characteristics of the remaining 133 subjects (91 females, 42 males) were: age: 35.8 (range 18-60) y; BMI: 24.8 (range 21.0-34.6) kg/m².

### Study Products

Each subject was given a single exposure to a single portion of a foamed liquid at a specified volume at 10.30 following a fixed breakfast at 08.00. Details of the 250 kcal breakfast bar (Jordans Absolute Nut Luxury Bar) are shown in Table 1. Six foam products were evaluated varying in total volume.

TABLE 1
Nutrient composition of breakfast bar

| | Per 100 g | Per 45 g bar |
|---|---|---|
| Energy (kJ) | 2314 | 1041 |
| Energy (kcal) | 557 | 250 |
| Protein | 12.7 g | 5.7 g |
| Carbohydrate | 33.3 g | 15.0 g |
| of which Sugars | 16.1 g | 7.2 g |
| Fat | 41.4 g | 18.6 g |
| of which Saturates | 4.0 g | 1.8 g |
| Mono-unsaturates | 28.0 g | 12.6 g |
| Polyunsaturates | 7.4 g | 3.3 g |
| Fibre | | 3.2 g |
| Sodium | Trace | Trace |

The test products consisted of SlimFast Optima high protein ready-to-drink meal replacement shakes (190 kcal/325 ml when not aerated), aerated on site with N₂O (from an iSi dispenser and using an iSi N₂O disposable gas filled cylinder) (SlimFast is a trademark of Unilever PLC, United Kingdom and Unilever NV, Netherlands; iSi is a tradename of iSi GmbH, Vienna, Austria). Nutrition facts and ingredients list of the non-aerated SlimFast high protein chocolate RTD shake base are shown in Table 2. The liquid formulation used was the same as the commercial product identified above, but with a different chocolate flavouring component. The overrun of the product (overrun=100*foam volume/liquid volume) was approximately 200%. This means that the energy content per serving was approximately 2, 5, 10, 19, 29 and 48 kcal for the 10, 25, 50, 100, 150 and 250 ml aerated servings (corresponding to approx. weights of 4, 11, 18, 35, 50 and 85 gram servings), respectively.

TABLE 2
Nutrient composition of Slim•Fast High Protein
Extra Creamy Chocolate RTD shake (US formulation)

Amounts per can (325 ml)
Calories 190
Total Fat 5 g
Saturated Fat 2 g
Cholesterol 10 mg
Sodium 220 mg
Potassium 600 mg
Total Carbohydrate 24 g
Dietary Fiber 5 g
Sugars 13 g
Protein 15 g
+Vitamin-Mineral complex

Ingredients: Fat Free Milk, Water, Calcium Caseinate, Milk Protein Concentrate, Maltodextrin, Cocoa (Processed with Alkali), Canola Oil, Gum Arabic, Cellulose Gel, Sugar, Mono and Diglycerides, Fructose, Potassium Phosphate, Soybean Lecithin, Cellulose Gum, Carrageenan, Artificial Flavor, Isolated Soy Protein, Sucralose and Acesulfame Potassium (Non Nutritive Sweeteners), Dextrose, Potassium Carrageenan, Citric Acid and Sodium Citrate. Vitamins and Minerals: Magnesium Phosphate, Calcium Phosphate, Sodium Ascorbate, Vitamin E Acetate, Zinc Gluconate, Ferric Orthophosphate, Niacinamide, Calcium Pantothenate, Manganese Sulfate, Vitamin A Palmitate, Pyridoxine Hydrochloride, Riboflavin, Thiamin Mononitrate, Folic Acid, Chromium Chloride, Biotin, Sodium Molybdate, Potassium Iodide, Phylloquinone (Vitamin K1), Sodium Selenite, Cyanocobalamin (Vitamin B12) and Cholecalciferol (Vitamin D3).

At least 24 hours before the test day the SlimFast high protein chocolate RTD was stored at 5° C., while the iSi N₂O gas filled cylinder and dispensers were stored at room temperature. All test products were presented in an accompanying beaker. All foams were consumed with a 10 ml black plastic spoon and the subjects were instructed to eat all of the foam within 10 minutes. All test products were prepared on the test days, according to a standard operating procedure. In short, the content of one 325 ml can of Slim-Fast high protein chocolate shake was poured into the stainless steel iSi bottle and the device head was screwed onto the stainless steel bottle One iSi N₂O gas filled cylinder was inserted into the cylinder holder and the cylinder holder was screwed to the device head until all of the content of the cylinder was released into the bottle. Thereafter the device was vigorously shaken for 20 seconds. The foam was then dispensed by turning the device upside down with the decorator tip in the vertical position and gently pressing the lever. The entire amount (˜900 ml) was dispensed against the inside edge of a large glass container and then the required foam volumes was poured into glasses which had been pre-marked with the required volume. The weight of the foam was subsequently measured.

### Subjective Feelings of Hunger and Satiety

Self-report ratings for appetite measures were collected at time points of −155, −120, −90, −60, −30, −5, 15, 30, 60, 90, 120, 150, and 180 min (where test product consumption at 1030 was regarded as 0 min). For an overview see Appendix 1.

Ratings of satiety feelings were scored using reproducible and valid scales (Stubbs et al., 2000; Flint et al. 2000) by means of a mark on 60-mm scales using EVAS (Electronic Visual Analogue Scale, iPAQ; Stratton et al. 1998) (iPAQ is a trademark of Hewlett Packard, USA) anchored at the low end with the most negative or lowest intensity feelings (e.g., not at all), and with opposing terms at the high end (e.g., very high). Volunteers were asked to indicate on a line which place on the scale best reflects their feelings at that moment. The scale items were “desire to eat a meal”, “desire to eat a snack”, “hunger”, “how much do you want to eat”, “satiety” and “fullness”.

### Analyses

The study was a product benchmarking study, aimed to generate a dose-response profile for satiety effects, focused on identifying lower volume limits for potential consumer concepts. Curves of Least Square means (LSmeans) were produced based on the measurements, and based on these curves a time-to-return-to-baseline (TTRTB) was calculated by using a modeling technique based on the Weibull distribution (Schuring et al 2008). This Weibull method also turned out to be the most suitable, non-parametric model to estimate TTRTB for these satiety curves.

### Results

The consumption of small portions of foam in between meals (i.e. as a snack) induced clear effects on eating motivational ratings. An example of the effect of the 6 foam volumes is shown for desire to eat a meal (FIG. 1a), desire to eat a snack (FIG. 1b) and hunger (FIG. 1c).

The results indicate a rough dose-response, although this is not completely consistent across the different line scales used. Strongest, robust effects are shown for 250 ml, while no effect is observed for the 10 or 25 ml. For 10 and 25 ml the TTRTB estimates could not be calculated, as the curves did not cross the baseline. This is consistent for all line scales. Surprisingly, effects were also observed for the 50, 100 and 150 ml where intermediate effects were seen. In 4 out of 6 line scales the effect of 150 ml on peak and duration is somewhat more pronounced than the 50 and 100 ml, but for all line scales the 50, 100 and 150 ml volumes showed greater responses as compared to the 10 and 25 ml.

Based on these data, the TTRTB was calculated (see Tables 2a, 2b and 2c). TTRTB values were consistent with the outcomes as can be judged visually from FIGS. 1a to 1c.

TABLE 2a
Time to return to baseline (TTRTB) for ‘Desire to eat a meal’

Foam volume, ml

| Measure | 10 | 25 | 50 | 100 | 150 | 250 |
|---|---|---|---|---|---|---|
| TTRTB¹ | — | — | 41 | 45 | 69 | 96 |

¹TTRTB (minutes) by Weibull modeling

TABLE 2b
Time to return to baseline (TTRTB) for ‘Desire to eat a snack’

Foam volume, ml

| Measure | 10 | 25 | 50 | 100 | 150 | 250 |
|---|---|---|---|---|---|---|
| TTRTB¹ | — | — | 89 | 93 | 86 | 180 |

¹TTRTB (minutes) by Weibull modeling

TABLE 2c
Time to return to baseline (TTRTB) for ‘Hunger’

Foam volume, ml

| Measure | 10 | 25 | 50 | 100 | 150 | 250 |
|---|---|---|---|---|---|---|
| TTRTB¹ | — | — | 79 | 80 | 66 | 120 |

¹TTRTB (minutes) by Weibull modeling

### DISCUSSION

A previous study has shown that aeration of liquid meal replacements leads to a high magnitude and duration of hunger suppression (increased satiety), which is substantially greater than non-aerated control products (De Groot et al., 2008; Blijdenstein et al., 2008) and also greater than examples in literature (e.g., Rolls et al., 2000; Osterholt et al., 2007). In that study the foam was consumed as a breakfast. It was, however, unknown, at what minimum volume a meaningful effect on satiety could still be observed. A quick estimate of response profiles to 6 foam volumes (10-250 ml) was therefore established.

The results indicate a rough dose-response. Strongest, robust effects are shown for 250 ml, while no effect is observed for the 10 or 25 ml. This was consistent for all line scales. Surprisingly, effects were also observed for the 50, 100 and 150 ml where intermediate effects were seen. In 4 out of 6 line scales the effect of 150 ml on peak and duration is somewhat more pronounced than the 50 and 100 ml, but for all line scales the 50, 100 and 150 ml volumes showed greater (and longer) responses as compared to the 10 and 25 ml.

The 50 ml and 100 ml contained only 10 and 19 kcal per serving respectively, yet showed meaningful effects on appetite. The effects on appetite observed here are greater (and persist for longer) than shown in literature for beverages having either no caloric content or a caloric content which is higher than the foams now tested, at the same volume. Peters et al. (2011) for instance tested a 100 ml minidrink as a snack and effects on hunger and appetite were comparable or even smaller compared to the effects seen here for the 50 or 100 ml foam, yet the 100 ml minidrink contained considerably more energy (80 kcal). Comparable or even smaller effects on appetite were also seen when testing 150 ml soup containing 150 kcal (Gray et al 2002) or 300 ml dairy-based drink containing 500 kcal (Rolls et al 2000). Although plain water or artificially sweetened water do decrease appetite, volumes needed are much higher and the temporal effect is much shorter as compared to the 50 or 100 ml foam (e.g. Monsivais et al., 2007)

TTRTB values were consistent with what can be observed from the graphical representations in FIGS. 1a-1c in the current study. The 250 ml volume led to an appetite response with an estimated TTRTB of 96 to 180 minutes, depending on the appetite rating used. Also the 100 and 150 ml volume produced a meaningful increase in TTRTB, generally between 45 and 93 min, depending on the appetite rating used. The 50 ml also generated a meaningful increase in TTRTB varying from 41 to 89 minutes, depending on the appetite rating used. For the 25 and 10 ml these values could not be estimated, as the curves did not cross the baseline (in the majority of subjects).

TTRTB/kcal for hunger: 79/10, 80/19, 66/29 and 120/48=7.9, 4.2, 2.3 and 2.5 min/kcal for the 50, 100, 150 and 250 ml servings.

TTRTB/kcal for desire to eat a meal: 41/10, 45/19, 69/29 and 96/48=4.1, 2.4, 2.4 and 2.0 min/kcal for the 50, 100, 150 and 250 ml servings.

### REFERENCES

Blijdenstein T B J, Cox J, De Groot P, Liu W, Stoyanov S D, Zhou W. Patent WO 2008/046699. Aerated food product and process for preparing it.
Fedoroff I, Polivy J, Herman C P. The specificity of restrained versus unrestrained eaters' responses to food cues: general desire to eat, or craving for the cued food? Appetite 2003; 41(1):7-13.
Flint A, Raben A, Blundell J E, Astrup A. Reproducibility, power and validity of visual analogue scares in assessment of appetite sensations in single test meal studies. International Journal Of Obesity 2000; 24:38-48.
Groot de, P. W. N., Kovacs, E. M. R., Melnikov, S. M., Monferrer, J., & Stoyanov, S. S. (2008). The effects of gas-filled liquid foods on appetite. International Journal Of Obesity, 32, S83.
Gray, R. W., French, S. J., Robinson, T. M., & Yeomans, M. R. (2002). Dissociation of the effects of preload volume and energy content on subjective appetite and food intake. Physiology & Behavior, 76, 57-64
Monsivais, P., Perrigue, M. M., & Drewnowski, A. (2007). Sugars and satiety: does the type of sweetener make a difference? American Journal Of Clinical Nutrition, 86, 116-123.
Morgan J F, Reid F, Lacey J H. The SCOFF questionnaire: assessment of a new screening tool for eating disorders. Br Med J 1999; 319:1467-1468.
Osterholt K M, Roe L S, Rolls B J. Incorporation of air into a snack food reduces energy intake. Appetite 2007; 48:351-8.
Peters H P F, Foltz M, Kovacs E M R, Mela D J, Schuring E A H, Wiseman S A. The effect of protease inhibitors derived from potato formulated in a minidrink on appetite, food intake and plasma cholecystokinin levels in humans. Int J Obesity 35, 244-250, 2011
Polivy J, Herman C P, Warsh S. Internal and external components of emotionality in restrained and unrestrained eaters. J Abnormal Psychol 1978; 87:497-504.
Rolls B J, Bell E A, Waugh B A. Increasing the volume of a food by incorporating air affects satiety in men. Am J Clin Nutr 2000; 72:361-8.
Schuring, E. A. H., Quadt, J. F. A., Kovacs, E. M. R., Wiseman, S., Haddeman, E., & Mela, D. J. (2008). Statistical design and analysis of satiety trials comparing foods and food ingredients. International Journal Of Obesity, 32, S197.
Stratton R J, Stubbs R J, Hughes D, King N, Blundell J E, Elia M. Comparison of the traditional paper visual analogue scale questionnaire with an Apple Newton electronic appetite rating system (EARS) in free living subjects feeding ad libitum. European Journal Of Clinical Nutrition 1998; 52:737-41.
Stubbs R J, Hughes D A, Johnstone A M et al. The use of visual analogue scales to assess motivation to eat in human subjects: a review of their reliability and validity with an evaluation of new hand-held computerized systems for temporal tracking of appetite ratings. British Journal of Nutrition 2000; 84:405-15.

### BRIEF DESCRIPTION OF FIGURES

FIG. 1a. The effect of different foam volumes on subjective feelings of desire to eat a meal (LSmeans based on baseline values, n=133).

FIG. 1b. The effect of different foam volumes on subjective feelings of desire to eat a snack (LSmeans based on baseline values, n=133).

FIG. 1c. The effect of different foam volumes on subjective feelings of hunger (LSmeans based on baseline values, n=133).

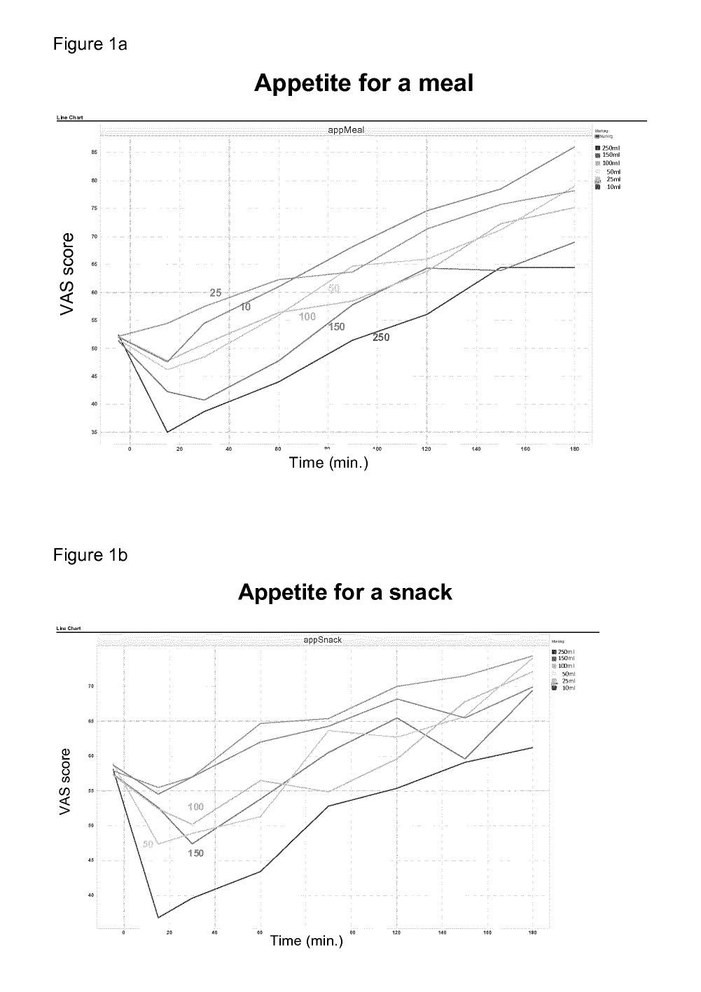

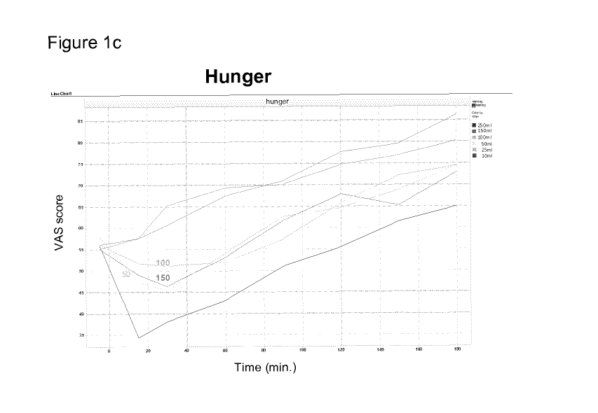

1. Method for reducing, in an individual, the desire to eat a meal or a snack in between meals,
which method comprises consuming by said individual, in between meals or as an adjunct to a meal,
a portion of at least 50 ml and less than 100 ml, of an edible aerated composition, which aerated composition:
is pourable or spoonable,
has an overrun of at least 10.0%,
comprises by weight 50-99.5% water, a foaming agent and a stabiliser,
wherein the foaming agent comprises one or more of:
a water-soluble emulsifier having an HL B value of at least 8;
a food grade protein:
food grade amphiphatic particles having a contact angle at air/water interface between 70 and 120 degrees, and having a volume weighted mean diameter of 0.02 to 10 micron (μm),
and wherein the stabiliser comprises a dietary fibre or a sucrose ester, and
contains less than 50 kcal/portion.

2. Method according to claim 1, wherein reducing, in an individual, the desire to eat a meal or a snack in between meals comprises one or more of:
decreasing feelings of hunger in an individual,
increasing feelings of satiety in an individual,
decreasing individual's estimate of their prospective food consumption,
decreasing feelings of craving in an individual for food or a snack,
increasing feeling, in an individual, of fullness.
reducing appetite, in an individual, for a meal or a snack in between meals.

3. Method according to claim 1, wherein the aerated composition has a calorie density of less than 2 kcal/gram.

4. (canceled)

5. Method according claim 1, wherein the stabiliser is present in an amount of from 0.1 to 5% by weight.

6. Method according to claim 1, wherein the aerated composition has an overrun of at least 120%.

7. Method according to claim 1, wherein the aerated composition is packaged in a pressurised container in a non-aerated, liquid form.

8. Method according to claim 1, wherein the aerated composition has a foam stability such that said aerated composition has a bench-life stability of at least 1 hour, wherein bench-life is determined by the methodology defined in the description.

9. (canceled)

10. (canceled)

11. (canceled)

12. (canceled)

13. Use of an edible aerated composition, which aerated composition:
is pourable or spoonable,
has an overrun of at least 100%,
has a composition comprising by weight 50-99.5% water, a foaming agent and a stabiliser,
wherein the foaming agent comprises one or more of:
a water-soluble emulsifier having an HLB value of at least 8, preferably at least 9, more preferably at least 12;
a food grade protein;
food grade amphiphatic particles having a contact angle at air/water interface between 70 and 120 degrees, and having a volume weighted mean diameter of 0.02 to 10 micron (μm),
and wherein the stabiliser comprises a dietary fibre or a sucrose ester, and
contains less than 50 kcal/portion.
for reducing, in an individual, the desire to eat a meal or a snack in between meals, by consuming by said individual, in between meals or as an adjunct to a meal a portion of at least 50 ml and less than 100 ml, of said aerated composition.

14. An edible aerated composition which aerated composition:
is pourable or spoonable,
has an overrun of at least 100%,
has a composition comprising by weight 50-99.5% water, a foaming agent and a stabiliser,
wherein the foaming agent comprises one or more of:
a water-soluble emulsifier having an HLB value of at least 8.
a food grade protein;
food grade amphiphatic particles having a contact angle at air/water interface between 70 and 120 degrees, and having a volume weighted mean diameter of 0.02 to 10 micron (μm),
and wherein the stabiliser comprises a dietary fibre or a sucrose ester, and,
contains less than 50 kcal/portion.
said treatment comprising consuming by said individual, in between meals or as an adjunct to a meal, a portion of at least 50 nil and less than 100 ml, of said aerated composition.

15. (canceled)
